(19) United States
(12) Patent Application Publication
(10) Pub. No.: US 2009/0134203 A1
(43) Pub. Date: May 28, 2009

(54) METHODS AND APPARATUS FOR FORMING TUBULAR STRINGS

(75) Inventors: Brennan S. Domec, Lafayette, LA (US); Pradeep Kumar Mallenahalli, Broussard, LA (US); John Fletcher Wheeler, Aberdeen (GB)

Correspondence Address: Winstead PC (FCC-FKI);Henry L. Ehrlich, P.O. Box 50784, Dallas, TX, 75201, US

(73) Assignee: Frank's International, Inc., Houston, TX (US)

(21) Appl. No.: 12/324,313

(22) Filed: Nov. 26, 2008

Related U.S. Application Data
(60) Provisional application No. 60/990,762, filed on Nov. 28, 2007.
(60) Provisional application No. 61/076,488, filed on Jun. 27, 2008.

(51) Int. Cl. B23K 20/12

(52) U.S. Cl. 228/112.1; 228/2.1

(57) ABSTRACT

An embodiment of a method for interconnecting tubular sections includes the steps of vertically positioning a second tubular above a first tubular forming a seam defined by a bottom end of the second tubular and a top end of the first tubular; positioning a friction stir welder (FSW) proximate to the seam; aligning the first tubular and the second tubular to form a longitudinal axis; and guiding the FSW along the seam forming a weld joint.

### RELATED APPLICATIONS

This application claims the benefit of U.S. Provisional Patent Application No. 60/990,762 filed on Nov. 28, 2007, and U.S. Provisional Patent Application No. 61/076,488, filed on Jun. 27, 2008.

### TECHNICAL FIELD

The present invention relates in general to forming tubular strings and more particularly to interconnecting tubular segments utilizing friction stir welding.

### BACKGROUND

Tubular strings are utilized in a multitude of applications and environments including without limitation as pipelines and for borehole operations. For example, in wellbore applications tubulars are used to case the borehole, as production strings, as drillstrings, and for workover operations. In these applications, jointed pipe is typically vertically suspended over and in a wellbore and interconnected section by section as the completed string is lowered into the wellbore. In some applications, tubular sections are interconnected while vertically oriented and the constructed tubular string is disposed and laid substantially horizontally for example on a seafloor.

### SUMMARY

An embodiment of a method for interconnecting tubular sections includes the steps of vertically positioning a second tubular above a first tubular forming a seam defined by a bottom end of the second tubular and a top end of the first tubular defining a seam; positioning a friction stir welder (FSW) proximate to the seam; aligning the first tubular and the second tubular to form a longitudinal axis; and guiding the FSW along the seam forming a welded joint.

Another embodiment of a method for interconnecting tubular sections includes the steps of positioning an end of a first tubular and an end of a second tubular to form a seam defined by the ends; positioning a FSW proximate to the seam; guiding the FSW along the seam; and forming a weld joint.

An embodiment of a system for friction stir welding a seam formed between ends of adjacent tubulars includes a friction stir welder; and a guidance assembly operationally positioning the welder at the seam, wherein the guidance assembly moves the welder along the seam to form a weld joint.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a conceptual view of an embodiment of the friction stir welding system interconnecting vertically suspended tubular sections;

FIG. 2 is a conceptual view of an embodiment of a guidance system of the friction stir welding system shown in isolation;

FIG. 3 is an elevation view of an embodiment of a friction stir welding system providing a biased weld joint;

FIG. 4 is an elevation view of an embodiment of a quality control system of the friction stir welding system shown in isolation;

FIG. 5 is a cross-sectional view of an embodiment of an alignment tool internally positioned for providing a welded joint;

FIG. 6 is an elevation view of an embodiment of a backing tool; and

FIG. 7 is a perspective view of another embodiment of a friction stir welding system.

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; “top” and “bottom”; and other like terms indicating relative positions to a given point or element are utilized to more clearly describe some elements of the illustrated embodiments. Commonly, these terms relate to a common reference point to the described operations. For example, in regard to drilling operations the common reference point as the surface from which drilling operations are initiated. The terms “tubular,” “tubular member,” “casing,” “liner,” tubing,” “coiled tubing,” “continuous tubing,” “drillpipe,” “pipe,” and other like terms can be used interchangeably. The terms may be used in combination with “joint,” “segment,” “section,” “string” and other like terms referencing a length of tubular. The length of the tubular may be a pre-defined length, such as a thirty-foot joint of drillpipe, or may be an arbitrary length. It is further noted that tubular and like terms includes sand screens and the like and also includes expandable tubular members.

The illustrated embodiments disclose examples of methods and systems for forming tubular strings utilizing friction stir welding (“FSW”). Friction stir welding is described, for example, in U.S. Pat. No. 5,460,317 which is incorporated herein by reference. The illustrated embodiments are directed to interconnecting tubular segments that are oriented substantially vertical relative to the Earth to create a tubular string. For purposes of brevity and clarity the illustrated embodiments of the created tubular string are described with reference to use in a subterranean wellbore or borehole. It is readily understood that the disclosed systems and methods may be utilized in various manners and situations. One example includes the forming a tubular string on vessel such as a ship that lays the tubular string on a seafloor to serve as a pipeline.

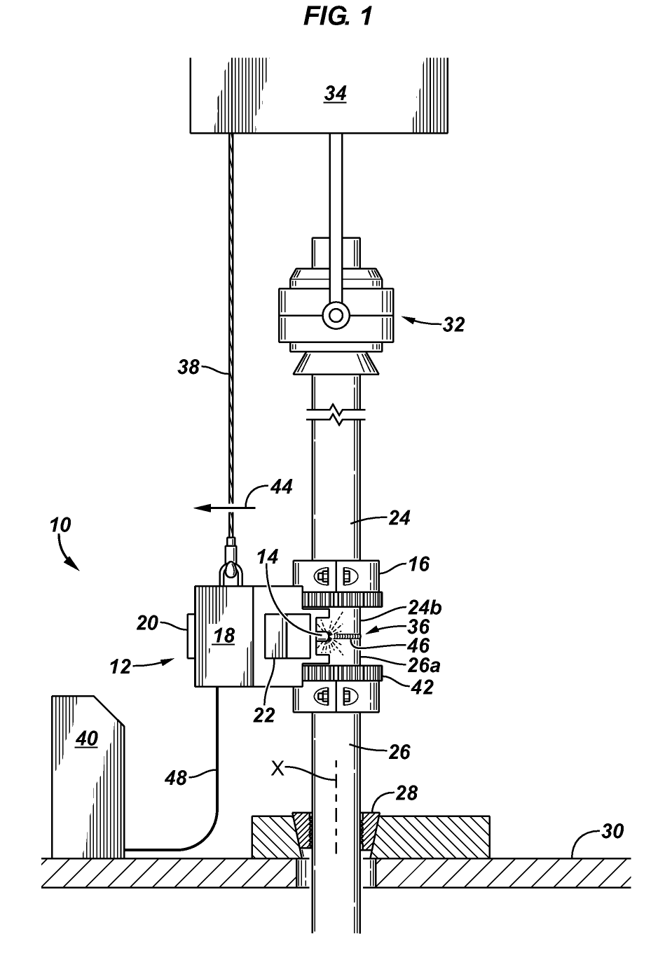

FIG. 1 is a conceptual view of an embodiment of friction stir welding (“FSW”) system of the present invention generally disclosed by the numeral 10. The illustrated system 10 includes a friction stir welder 12, a stir probe 14, tubular clamps 16, driving means 18, guiding system 20, and quality control system 22.

System 10 is illustrated in FIG. 1 connecting, by friction stir welding, a second tubular segment 24 to a first tubular segment 26 to form a tubular string. First tubular segment 26 is illustrated being held by slips 28 proximate to a floor 30. For purposes of description herein, floor 30 is utilized as a reference point in relation to terms such as “top,” “bottom,” “upper,” “lower,” and the like. In the described embodiment first tubular segment 26 is the top of a tubular string that is extending into a wellbore.

The second or top tubular segment 24 is illustrated as being held by a tubular gripping apparatus referred to herein generally as an elevator 32. Elevator 32 is illustrated herein as an external gripping apparatus, but may be an internal gripping apparatus. Elevator 32 may be suited to grip tubular 24 in a manner to transmit rotation to segment 24 and or the interconnected tubular string. Elevator 32 is illustrated as connected to hoisting system 34. Hoisting system 34 may include various systems and apparatus such as and without limitation top drives, kellys, traveling blocks, cranes and the like. Hoisting system 34 may be adapted to transmit rotation to tubular string.

Hoisting system 34 can be used to position the bottom end 24b of tubular segment 24 proximate to the top end 26a of tubular segment 26 for interconnection by friction stir welding. Segments 24, 26 are positioned such that the respective ends form a seam 36 to be welded. Seam 36 may include a gap between the respective segment ends or may be the abutting ends.

Welder 12 is adapted for movement into operational position with the tubular segments 24, 26 for welding the segments together at seam 36. Welder 12 may be moved into and out of welding position by a transport 38. Transport 38 may provide vertical and lateral movement of welder 12 relative to the aligned segments 24, 26 which is referred to herein as a longitudinal axis.

In the illustrated embodiment, transport 38 includes an arm connected between welder 12 and hoisting system 34. As will be understood further below, transport 38 may be operationally connected with one or more of an electronic processing controller 40, guidance system 20, driving device 18, and the like to moveably control movement of welder 12 and probe 14 relative to seam 36.

Various transport devices and systems 38, in addition to the illustrated embodiment, may be utilized to position welder 12 for operation. In one embodiment, transport system 38 may comprise a movable carriage or frame that that carries welder 12. The carriage may be moved on the rig floor, barge floor, or firing line along a track, channel, or groove or the like. Transport 38 and/or welder 12 may be suspended from the derrick, a J-lay tower, or firing line (e.g. S-lay).

In the illustrated embodiment, system 10 includes a pair of spaced apart external clamps 16 for positioning welder 12 in welding position relative to seam 36. Clamps 16 include a top clamp 16a and a bottom clamp 16b that are vertically spaced apart. Top clamp 16a is shown connected to segment 24 above seam 36 and opposing bottom clamp 16b is shown connected to segment 26 below seam 36. Clamps 16 may provide support to align segments 24 and 26 for welding. Alignment of segments 24 and 26 may be provided by other means such as internally positioned members singularly or in combination with clamps 16. Thus, system 10 may utilize zero external clamps, one external clamp, two external clamps, or more than two external clamps. System 10 may utilize an alignment member that is positioned inside of one of the tubulars or positioned across the seam and inside of both of aligned tubulars. System 10 may utilize more than one internal alignment member. The more than one utilized internal alignment members may be each positioned in the same tubular or in different tubulars. System 10 may utilize one or more internal alignment members in combination with the use of one or more external alignment clamps. System 10 may utilize one or more internal alignment members without the use of one or more external clamps. System 10 is not limited to the utilization of or inclusion of clamps. In other words, system 10 may exclude the use of external clamps and internal alignment members.

The illustrated system includes a driving device 18 that is connected to clamps 16 as illustrated by the gear teeth 42 shown on clamps 16. In the illustrated embodiment driving device 18 drives probe 14 orbitally about seam 36. FIG. 1 illustrates probe 14 being rotated orbitally about seam 36 in the direction 44 and creating a weld joint 46. Driving device 18 may also move probe 14 radially into and out of welding position with seam 36. In some embodiments, driving device 18 may provide longitudinal movement of probe 14 between opposing clamps 16. As will be further understood, driving device 18 may be operationally connected to controller 40, guidance system 20, and/or quality control system 22.

Some embodiments of system 10 include guidance system 20 to direct welder 12, and more specifically probe 14, about seam 36 to provide weld joint 46. Guidance system 20, and/or drive device 18, may include a cross-slide assembly to mount probe 14 in a manner facilitating the movement and adjustment of probe 14 along seam 36 and in operational distance relative to seam 36. In the illustrated embodiment, guidance system 20 is operationally connected to controller 40 and is positioned on welder 12. Controller 40 in this embodiment includes an electronic processing unit, appropriate software, and the like for receiving and analyzing inputs and for providing control and information outputs. Guidance system 20 may be connected to controller 40 wirelessly or through hard lines such as in bundle 48. Controller 40 may be positioned proximate to or distal from guidance system 20. Bundle 48 may include one or more control and/or power lines including without limitation hydraulic lines, pneumatic lines, electrical lines, and fiber optics.

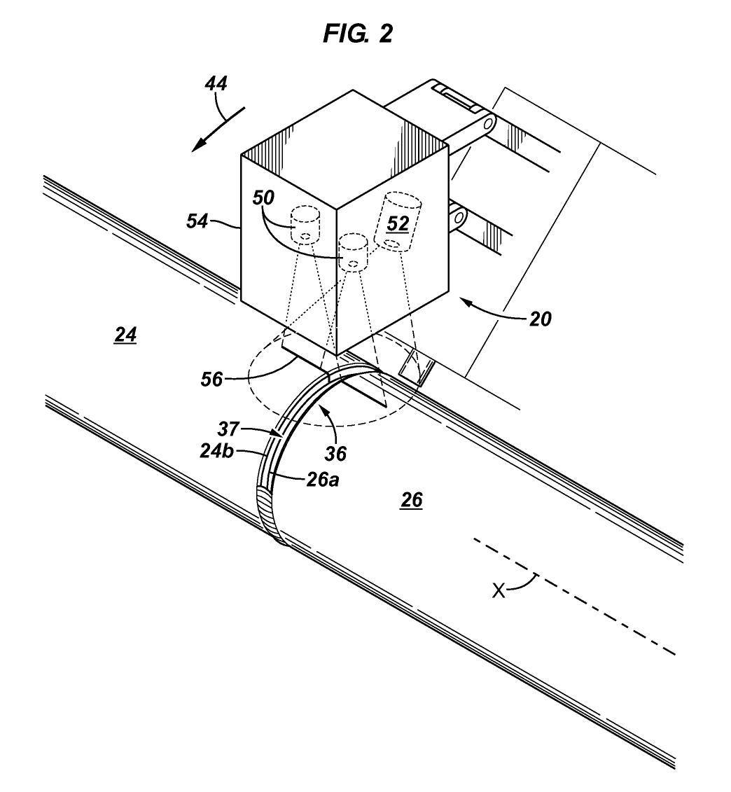

Refer now to FIG. 2 wherein one embodiment of a guidance system 20 is illustrated in isolation. This embodiment of guidance system 20 includes a laser type tomography system including one or more laser diodes 50 and a receiver 52 positioned within a housing 54. As shown in FIG. 1, system 20 is positioned proximate to seam 36 and stir probe 14 which is not shown in FIG. 2. FIG. 2 illustrates seam 36 including a gap 37 and also denotes the longitudinal axis of the aligned pipe segments with an “X”. Diodes 50 emit an optic fan 56 that spans across seam 36. Receiver 52, for example a camera, may be set at a triangulation angle to diodes 50 to receive the reflected optic signals. Receiver 52 can transmit signals relative to the received reflections to controller 40, or another, controller for analysis. Controller 40 can then provide data to an operator regarding tracking of seam 36 and/or operationally control the steering device to maintain stir probe 14 in welding positioning with seam 36. Examples of the steering device include without limitation driving device 18 and the illustrated transport 38. For example, driving device 18 may urge probe 14 radially toward and away from seam 36 as well as move probe longitudinally between opposing clamps 16. A cross-slide may be utilized within driving device 18. As previously described, transport 38 may provide longitudinal movement of welder 12 and probe 14 relative to seam 36 as well as provide radial movement.

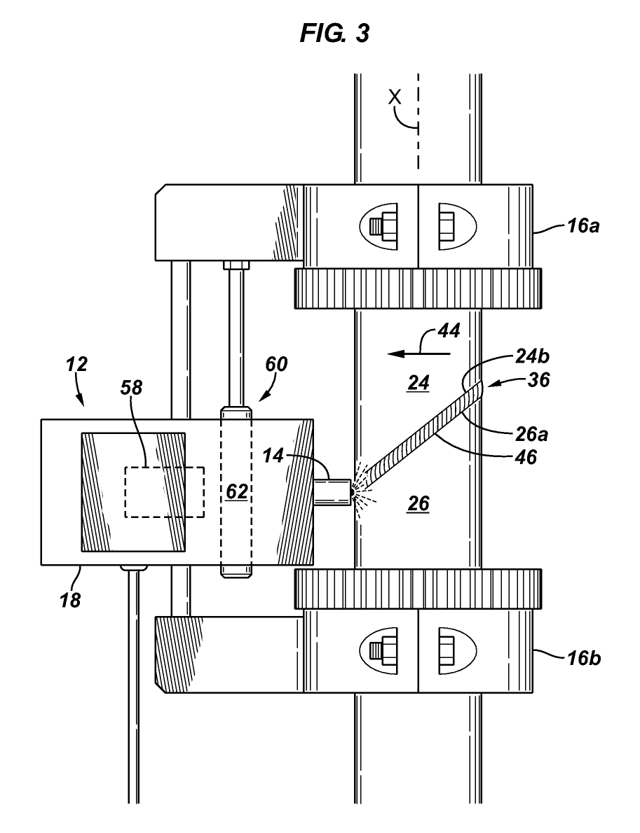

Refer now to FIG. 3 wherein a conceptual view of an embodiment of system 10 forming a biased weld joint 46. Seam 36 is oriented in a path that is biased or not perpendicular to the longitudinal axis of pipe segments 24, 26 and the tubular string. Referring back to FIGS. 1 and 2, guidance device 20 is provided on the leading side of welder 12 relative to the direction of orbit 44. Guidance device 20 has directed probe 14 circumferentially about tubulars 24, 26 forming joint weld 46. In this embodiment the steering device includes driving device 18 in combination with clamps 16. Top clamp 16a and bottom clamp 16b are spaced apart a distance sufficient to straddle seam 36. In the illustrated embodiment, drive device 18 provides movement of probe 14 longitudinally between clamps 16a and 16b, rotates probe 14 about seam 36, and can move probe 14 radially toward and away from seam 36.

Driving device 18 may include one or more motivational devices, including hydraulic systems, pneumatic systems, electrical systems, and the like. In the illustrated embodiment, drive device 18 is hydraulic operated. Device 18 can include a radial drive device 58 such as a hydraulic cylinder to drive probe 14 radially. Device 18 includes a longitudinal drive 60 interconnecting probe 46 and clamps 16a, 16b. In the illustrated embodiment, longitudinal drive 60 includes a hydraulic cylinder having a piston 62 connecting probe 14 to clamp 16a and 16b. The rotational or orbital movement can be provided by geared connections which are hydraulic driven in this embodiment. It is understood that various drive systems and devices including without limitation, acme screws, chain drives, belt drives and the like can be utilized.

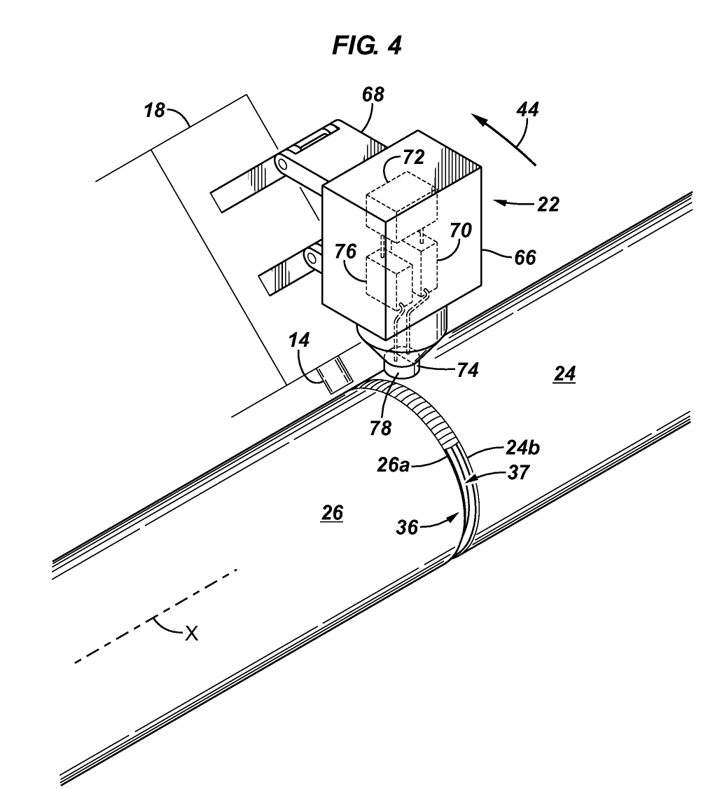

Refer now to FIG. 4 wherein an embodiment of a quality control device 22 is illustrated in isolation. Referring back to FIG. 1, device 22 can be provided in proximity to probe 14 and trailing the movement of probe 14. In this embodiment, quality control device 22 includes an ultrasonic (UT) testing device 66. In this embodiment, UT device 66 is movably connected, by connection 68, to the housing of drive device 18 which generally denotes the body of welder 12. UT apparatus 66 may include a signal generator 70 connected with a power source 72 and a signal emitter 74. Receiver 76 may be connected to a sensor 78 and power source 72. UT device 66 may be articulated and rotated about seam 36 to inspect the quality and integrity of weld 46 (FIG. 1). System 22 can be in operational connection with controller 40, or another system, to identify inadequate welds and may initiate remedial action.

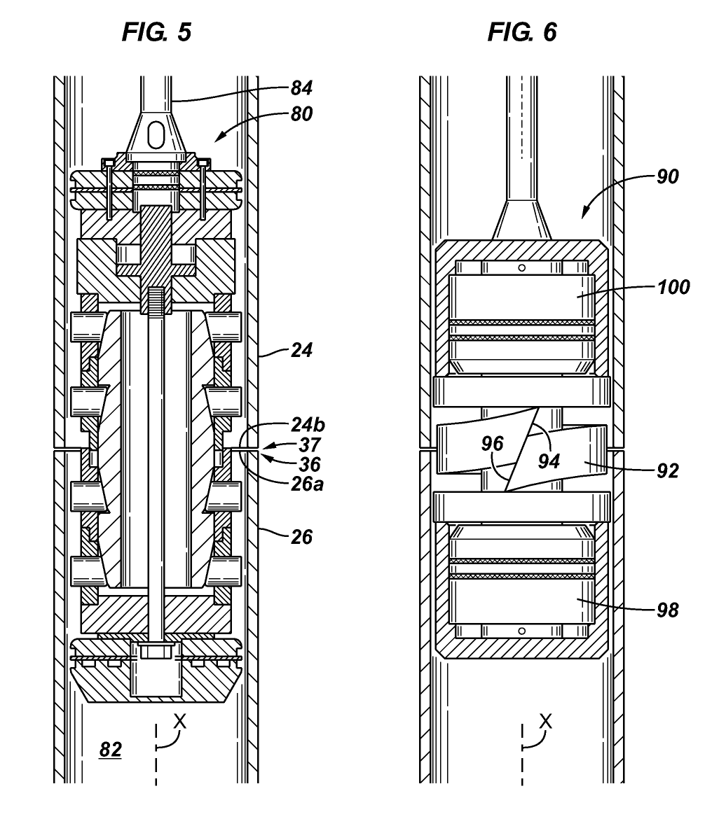

Refer now to FIG. 5 wherein an embodiment of an internal alignment device 80, or clamp, is illustrated. As previously noted it may be desired to utilize an internal alignment device 80 in place of or in addition to external alignment clamps 16. Tool 80 may be positioned in the bore 82 of the tubular to straddle seam 36 by a conveyance 84. Conveyance 84 may be a tubular, wireline, slickline, wire cable, rope, tether or other similar member. Internal alignment tool 80 may be an alignment tool such as that described in U.S. Pat. No. 6,392,193, which is incorporated by reference herein.

In the illustrated embodiment, conveyance 84 is tubing and may be utilized to provide fluid to and/or from tool 80. For example, a fluid such as an inert purge gas may be provided to seam 36 through conveyance 84. In some embodiments, tool 80 includes an internal bore to convey fluid across tool 80. In some embodiments tool 80 includes seal members to seal with tubulars 24 and/or tubulars 26 to provide fillup and/or circulation functionality.

Due to the forces applied at the seam during friction stir welding an internal backing tool may be utilized. In some embodiments alignment tool 80 may serve as the backing tool. Refer now to FIG. 6, with reference to FIG. 1, illustrating an embodiment of a backing tool 90 that can be positioned within the bore of the tubulars straddling seam 36. Tool 90 includes a cylindrical engaging member 92 that is split forming opposing biased surfaces 94, 96. In a run-in position, surfaces 94, 96 are offset from one another such that the outer diameter of member 92 is reduced for running into the tubulars. Tool 90 can be actuated, for example by operating opposing hydraulic cylinders 98, 100, moving surfaces 94, 96 into alignment with one another expanding member 92 outward into engagement with tubulars 24, 26 across seam 36.

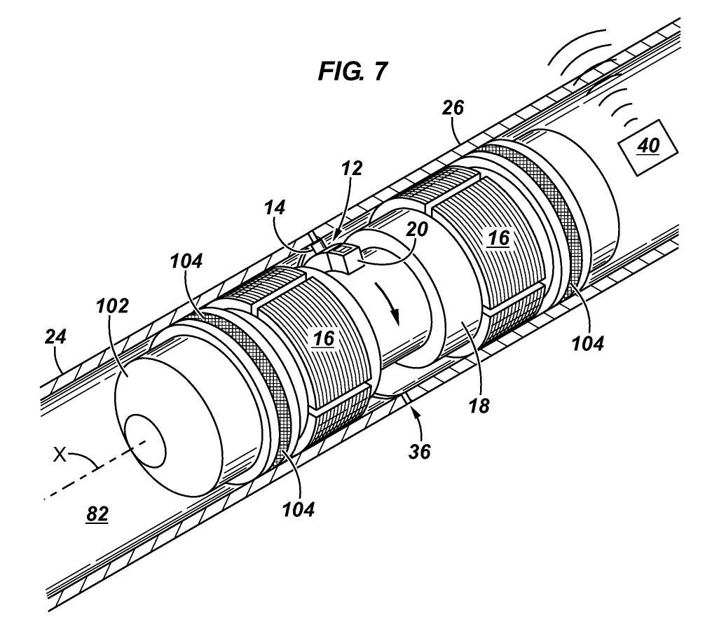

Refer now to FIG. 7, wherein another embodiment of a friction stir welding system 10 is illustrated disposed in the internal bore 82 of tubulars 24 and 26 across seam 36. In this embodiment FSW welder 12 is moveably connected to a pig body 102 at drive device 18. Drive device 18 is adapted to move probe 14 circumferentially about the longitudinal axis X of body 102. Body 102 may include opposing seal members 104 to seal against tubulars 24 and 26. Opposing clamps 16 can be extended radially to contact tubulars 24 and 26 to stabilize and align the tubulars for welding. System 10 can include probe guidance system 20. Although not illustrated, system 10 may include a quality control system. Controller 40 may be carried on-board of pig body 102 or located remotely.

A method of utilizing system 10 may include a step of preheat treating. The preheating may be provided by an induction coil for example. Friction stir welding can impart a known amount of heat and a known hardness gradient into the welded tubulars. The resulting as-welded properties are typically high in hardness for many of the oilfield country tubular good (“OCTG”) grades (L80, N80, etc.). By preheat treating the tubular ends to an approximate mirror image of the hardness profile that results from non-preheat treated pipe, a hardness profile after FSW that is similar to that of the base metal may be achieved. Thus mitigating some hardness related disadvantages.

A method of utilizing system 10 may include reprocessing. After the FSW weld is made, the FSW probe may be used to Friction Stir Process (FSP) the weld by making another orbit with the probe in the weld seam. In essence, the second pass may temper the first pass, lowering the hardness. This may be accomplished with the same probe, a probe of different shape and design, or a pinless probe with just a shoulder.

A method of utilizing system 10 may include welding tubular members having different properties together and utilizing convention welding and FSW in combination. For example, friction stir welding an L80 member to another L80 member results in high hardness. In one embodiment for example, L80 tubulars and X80 tubulars are conventionally welded together providing a desired as-welded profile for L80-X80 segments. The X80 ends may then be interconnected by friction stir welding to achieve the desired as-welded hardness profile. The X80 members may be provides as pups and conventionally welded offsite and the FSW process performed on-site.

A method of utilizing system 10 may include post weld heat treating (PWHT) using for example an induction coil: The method may include using an induction coil to temper the friction stir weld seam. This may be completed in a short period of time, for example less than one minute.

A method of utilizing system 10 may include providing a consumable insert. A consumable ring may be disposed between the ends to be welded; wherein the ring has a chemistry that when combined with the base metal chemistry, results in favorable properties (i.e., micro-alloying, etc.). The consumable member may be sized such that its length is shorter than the diameter of the FSW probe pin. Thereby the friction stir welding can combine both the ring and the base materials together simultaneously, resulting in the favorable properties.

In the joining of tubulars, differences in ovality and axial and angular misalignment are often present during initial fit-up. This often requires geometric measuring of the faces of the work pieces in order to pre-select and array the ends to be joined together by identifying and reducing “highs” and “lows” that, if not properly aligned, could adversely affect the quality of the weld. The terms “highs” and “lows,” as used herein, refer to the radial mismatch between adjacent tubulars due to such anomalies as wall thickness variations, tubular ovality, straightness, etc. Also, the term “geometrically measuring,” also defined herein, may include direct or indirect inspection of the weld for “high” and “low” weld reinforcement, weld reentry angle and weld defects, etc. These examples of base material geometry difficulties can generate unacceptable weld profiles and characteristics which can increase probability of a fatigue crack initiating at the root or cap of the weld (ID or OD). Additionally, since the ends of the weld bevels are not melted during orbital friction stir welding, a larger high-low or offset may be tolerated as compared to conventional welding processes. Thus, exact machining, alignment, and measurement of work piece ends prior to welding may be eliminated or substantially reduced when using friction stir welding to achieve improved fatigue life with reduction in time and costs.

U.S. Pat. No. 6,392,193 generally describes different techniques that can be employed to achieve stringent weld geometries and weld profiles that can enhance fatigue life using conventional welding techniques (such as GMAW and GTAW). Note, conventional welding is generally described in U.S. Pat. No. 5,030,812, U.S. Pat. No. 6,313,426, U.S. Pat. No. 6,737,601, and U.S. Pat. No. 6,518,545. Conventionally, fatigue life can be enhanced by controlling essential variables such as selection of welding consumables, fit-up, amps, volts, seam travel speed, shielding gas, pre-heat, inter-pass temperatures, heat input, grinding techniques, and machining techniques. On the other hand, because friction stir welding is a solid state joining process, the essential variables will change according to the probe rotational velocity, probe load, probe profile, machining techniques, grinding techniques, and seam travel speed employed. Therefore, it would be advantageous to selectively control friction stir welding essential variables as to achieve acceptable weld geometries and profiles whereby fatigue resistance of the resulting welded tubular will be enhanced.

The shaped channel or groove may, for example, be shaped to impart to the weld root bead formed, by friction stir welding the seam from the exterior, a favorable reentry angle exceeding 130 degrees and/or a favorable weld reinforcement less than 0.10 inches, and to thereby create a generally more favorable friction stir weld for fatigue-resistant applications. This favorable weld profile and/or geometry is generally discussed in U.S. Pat. No. 6,392,193, as it relates to conventional welding processes, and is incorporated herein by reference.

An embodiment of a method of utilizing system 10 for drilling with casing is now described. A boring tool, such as a drill bit, is connected to a first tubular segment 26. A next tubular segment 24 is then connected to first tubular segment 26 utilizing FSW system 10 and the process continues as a tubular string is run into the wellbore. It is noted that the tubular string may include various combinations of tubulars and tools. For example, the tubular string in this example will include casing and may further include, drill collars, a mud motor, logging and measurement while drilling sensors and electronic packages, expandable tubulars such as screens and other tubulars, and other tubulars and wellbore tools that are known and become known in the field of well drilling. The tubular string may comprise various diameter, length and weight tubulars. The tubular string may be a tapered string that includes various diameter tubulars as well as expandable tubulars. The tubular string may include non-friction stir welding connections such as and without limitation threaded connection and conventional welds.

Rotation of the tubular string and or drilling device may be provided by a rotary table, top drive, mud motor, or the like. It is noted that a tubular string formed with friction stir welds may provided distinct advantages over convention drilling strings, such as the ability to bi-directionally rotate the string as well has providing connection that are less likely to fail due to fatigue compared to threaded connections.

When the tubular string is positioned as desired, the wellbore or a portion there of may be completed. In some instances it is desired to retrieve lower elements, such as the drill bit and bottomhole assembly. In these instances the desired elements may be disconnected from the tubular string, for example by cutting or backing off, and then retrieved from the wellbore. In many instances the elements to be retrieved have a larger diameter than at least a portion of the tubular string. Expandable tubulars may be utilized in these applications facilitating running an expansion tool to expand the expandable tubulars. Expandable tubulars may be desired even in installations in which retrievals are not planned.

From the foregoing detailed description of specific embodiments of the invention, it should be apparent that systems and methods for forming tubular strings that are novel have been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A method for interconnecting tubular sections, the method comprising the steps of:
vertically positioning a second tubular above a first tubular forming a seam defined by a bottom end of the second tubular and a top end of the first tubular;
positioning a friction stir welder (FSW) proximate to the seam;
aligning the first tubular and the second tubular to form a longitudinal axis;
guiding the FSW along the seam; and
forming a weld joint.

2. The method of claim 1, wherein the FSW is positioned inside of the tubulars.

3. The method of claim 1, wherein the step of aligning includes positioning an alignment tool inside of the tubulars and across the seam.

4. The method of claim 3, further including the step of positioning a backing inside of the tubulars and aligned across the seam from the FSW.

5. The method of claim 4, wherein the backing is the alignment tool.

6. The method of claim 1, wherein the step of guiding the FSW includes disposing a guidance system with the FSW.

7. The method of claim 6, wherein the guidance system comprises a laser tomography apparatus.

8. The method of claim 1, further including the step of inspecting the weld joint as the FSW moves along the seam forming the weld joint.

9. The method of claim 8, wherein the step of inspecting is performed by an inspecting apparatus disposed with the FSW.

10. The method of claim 9, wherein the inspecting apparatus comprises an ultrasonic testing system.

11. The method of claim 1, wherein the seam is not perpendicular to the longitudinal axis of the aligned tubulars.

12. The method of claim 3, wherein the step of guiding the FSW includes disposing a guidance system with the FSW.

13. The method of claim 12, further including the step of positioning a backing inside of the tubulars and aligned across the seam from the FSW.

14. The method of claim 13, wherein the backing is the alignment tool.

15. The method of claim 12, wherein the guidance system comprises a laser tomography apparatus.

16. The method of claim 3, further including the step of inspecting the weld joint as the FSW moves along the seam forming the weld joint.

17. The method of claim 6, further including the step of inspecting the weld joint as the FSW moves along the seam forming the weld joint.

18. The method of claim 12, further including the step of inspecting the weld joint as the FSW moves along the seam forming the weld joint.

19. The method of claim 12, wherein the seam is not perpendicular to the longitudinal axis of the aligned tubulars.

20. The method of claim 16, wherein the seam is not perpendicular to the longitudinal axis of the aligned tubulars.

21. The method of claim 2, wherein the step of aligning includes disposing an alignment apparatus inside of the tubulars.

22. The method of claim 2, wherein the step of guiding the FSW includes disposing a guidance system with the FSW.

23. The method of claim 2, further including the step of inspecting the weld joint as the FSW moves along the seam forming the weld joint.

24. The method of claim 2, wherein the seam is not perpendicular to the longitudinal axis of the aligned tubulars.

25. The method of claim 21, wherein the step of guiding the FSW includes disposing a guidance system with the FSW; and
further including the step of inspecting the weld joint as the FSW moves along the seam forming the weld joint.

26. The method of claim 25, wherein the seam is not perpendicular to the longitudinal axis of the aligned tubulars.

27. The method of claim 1, wherein the step of aligning includes disposing at least one external alignment clamp in connection with one or more of the tubulars.

28. The method of claim 27, wherein the step of aligning includes positioning an alignment tool inside of one or more of the tubulars.

29. The method of claim 1, wherein the tubulars are aligned without an external alignment clamp or an internal alignment clamp.

30. The method of claim 1, wherein the step of forming the friction stir weld joint includes, shaping the weld joint to have a re-entry angle exceeding 130 degrees and to limit the reinforcement to less than 0.10 inch.

31. The method of claim 30, wherein the step of shaping including selectively controlling at least one friction stir welding parameter

32. The method of claim 30, wherein the step of shaping includes removing at least a portion of the friction stir weld joint.

33. The method of claim 30, further including the step of friction stir processing the friction stir weld joint to obtain desired mechanical properties.

34. The method of claim 1, further including the step of heating the friction stir weld joint.

35. The method of claim 34, wherein the heating is provided by an induction coil.

36. The method of claim 1, further including the step of pre-heat treating the tubulars proximate to the seam to obtain a first hardness profile; wherein the step of forming the weld joint provides a second hardness profile.

37. The method of claim 1, further comprising the step of disposing a consumable ring of pre-defined material at the seam prior to forming the weld joint.

38. The method of claim 1, wherein the step of guiding utilizes a cross-slide assembly.

39. A method for interconnecting tubular sections, the method comprising the steps of:
positioning an end of a first tubular and an end of a second tubular to form a seam defined by the ends;
positioning a friction stir welder (FSW) proximate to the seam;
guiding the FSW along the seam; and
forming a weld joint.

40. The method of claim 39, further including the step of aligning the tubulars along a longitudinal axis.

41. The method of claim 39, including utilizing at least one external alignment clamp to align the tubulars.

42. The method of claim 39, including utilizing at least two external alignment clamps to align the tubulars.

43. The method of claim 39, wherein the tubulars are aligned along a longitudinal axis without using an external alignment clamp.

44. The method of claim 39, wherein the tubulars are aligned along a longitudinal axis without using an internal alignment apparatus.

45. The method of claim 39, wherein the tubulars are aligned along a longitudinal axis without using an internal alignment apparatus or an external alignment clamp.

46. The method of claim 39, including utilizing at least one alignment apparatus disposed inside of one or both of the tubulars.

47. The method of claim 39, wherein the tubulars positioned vertically prior to forming the weld joint.

48. The method of claim 39, wherein the step of forming the friction stir weld joint includes, shaping the weld joint to have a re-entry angle exceeding 130 degrees and to limit the reinforcement to less than 0.10 inch.

49. The method of claim 48, wherein the step of shaping including selectively controlling at least one friction stir welding parameter

50. The method of claim 48, wherein the step of shaping includes removing at least a portion of the friction stir weld joint.

51. The method of claim 48, further including the step of friction stir processing the friction stir weld joint to obtain desired mechanical properties.

52. The method of claim 39, further including the step of heating the friction stir weld joint.

53. The method of claim 52, wherein the heating is provided by an induction coil.

54. The method of claim 39, further including the step of pre-heat treating the tubulars proximate to the seam to obtain a first hardness profile; wherein the step of forming the weld joint provides a second hardness profile.

55. The method of claim 39, further comprising the step of disposing a consumable ring of pre-defined material at the seam prior to forming the weld joint.

56. The method of claim 39, wherein the step of guiding utilizes a cross-slide assembly.

57. The method of claim 39, wherein the step of guiding includes disposing a guidance system with the FSW.

58. The method of claim 57, wherein the guidance system utilizes a cross-slide assembly.

59. The method of claim 57, wherein the guidance system includes a laser tomography apparatus.

60. A system for friction stir welding a seam formed between ends of adjacent tubulars comprises:
a friction stir welder; and
a guidance assembly operationally positioning the welder at the seam, wherein the guidance assembly moves the welder along the seam to form a weld joint.

61. The system of claim 60, wherein the guidance assembly includes a cross-slide assembly.

62. The system of claim 60, further including at least one alignment member disposed to align the adjacent tubulars along a substantially longitudinal axis.

63. The system of claim 62, wherein the at least one alignment member is a clamp positioned external to the tubulars.

64. The system of claim 62, wherein the at least one alignment member is an apparatus positioned internal of the tubulars.
